(19) United States
(12) Patent Application Publication
(10) Pub. No.: US 2018/0154343 A1
(43) Pub. Date: Jun. 7, 2018

(54) HYDROPROCESSING CATALYST AND METHOD FOR PREPARING SAME

(71) Applicant: SK INNOVATION CO., LTD., Seoul (KR)

(72) Inventors: Sang Il LEE, Daejeon (KR); Do Woan KIM, Daejeon (KR); Jae Hyun KOH, Daejeon (KR); Seung Hoon OH, Seoul (KR); Hee Jung JEON, Daejeon (KR); Sang Heup MOON, Seoul (KR); A Ra CHO, Seongnam-si (KR); Young Moo PARK, Daejeon (KR)

(73) Assignee: SK INNOVATION CO., LTD., Seoul (KR)

(21) Appl. No.: 15/883,862

(22) Filed: Jan. 30, 2018

Related U.S. Application Data
(62) Division of application No. 15/227,190, filed on Aug. 3, 2016.
Application No. 15/227,190 is a continuation-in-part of application No. 13/992,696, filed on Jun. 7, 2013, now abandoned.

(30) Foreign Application Priority Data
Dec. 9, 2010 (KR) 10-2010-0125461
Dec. 8, 2011 (KR) 10-2011-0131237

(51) Int. Cl. B01J 31/02; C10G 45/08; B01J 37/06; B01J 31/34; B01J 31/38; B01J 37/08; B01J 37/02; B01J 23/888; B01J 23/88; B01J 35/02; B01J 31/22; B01J 31/12; B01J 37/20; B01J 37/18; B01J 23/882

(52) U.S. Cl. CPC B01J 31/0209; C10G 45/08; B01J 23/882; B01J 31/34; B01J 31/38; B01J 37/08; B01J 37/0236; B01J 37/024; B01J 31/0208; B01J 31/0207; B01J 31/0201; B01J 23/888; B01J 23/88; B01J 37/0219; B01J 2531/847; B01J 2531/845; B01J 2531/66; B01J 2531/64; B01J 37/0201; B01J 35/023; B01J 31/2234; B01J 31/2213; B01J 31/2208; B01J 31/12; B01J 37/0205; B01J 37/20; B01J 37/18; B01J 37/06

(57) ABSTRACT

Embodiments of the invention relate to a method for preparing a hydroprocessing catalyst including supporting a carrier with one or more hydrogenation metal components selected from the group consisting of VIB, VIIB, and VIII group metals of the periodic table; drying and calcining the supported carrier having the hydrogenation metal components; supporting the supported carrier having the hydrogenation metal components with an organic compound, and drying and calcining the supported carrier having the hydrogenation metal components and the organic compound. The hydrogenation metal components and the organic compound are supported in the carrier. The organic compound is selected from the group consisting of methyl acetoacetate, ethyl acetoacetate and a mixture thereof. The hydrogenation metal components supported in the carrier is sulfide. An amount of the organic compound is 15 wt % to 90 wt % based on the total amount of the hydroprocessing catalyst.

### RELATED APPLICATIONS

This application is a divisional of and claims priority to and the benefit of U.S. patent application Ser. No. 15/227,190 filed on Aug. 3, 2016, and claims priority to, U.S. patent application Ser. No. 13/992,696, filed on Jun. 7, 2013, which claims priority to PCT Patent Application No. PCT/KR2011/009495, filed on Dec. 9, 2011, which claims priority to Korean Patent Application Serial Nos. 10-2010-0125461, filed on Dec. 9, 2010, and 10-2011-0131237, filed on Dec. 8, 2011, the disclosures of which are incorporated herein by reference in their entirety.

### BACKGROUND

### Field

Embodiments of the invention relate to a hydroprocessing catalyst used in hydrorefining, hydrotreating and hydrocracking processes, and a method of preparing the same.

### Description of the Related Art

In conventional hydrorefining, particularly, desulfurization and denitrogenation reactions of hydrocarbon oil derived from petroleum fractions or coal, a catalyst including a carrier supported with at least one selected from among VIB group metal elements in the periodic table, such as molybdenum, tungsten and the like, VIII group metal elements in the periodic table, such as cobalt, nickel and the like, and combinations thereof has been used.

VIB group metals in the periodic table (for example, tungsten and molybdenum) and oxides and sulfides thereof are known to be active in catalyzing various kinds of reactions such as hydrogenation, dehydrogenation, oxidation, deoxygenation, desulfurization, denitrogenation, isomerization, cracking and the like.

When VIII group metals in the periodic table (for example, iron, cobalt and nickel) are combined with VIB group metals and then used, catalytic activity is known to be improved. Such VIII group metals are often referred to as co-catalysts (promoters) of a catalyst.

It is known in the prior art that high-activity active sites are formed when such a co-catalyst is used. Particularly, in the case of a hydroprocessing catalyst, Co(or Ni)Mo(or W)S are known as high-activity active sites. In order to accelerate the formation of high-activity active sites, research into highly dispersing Mo(or W)S₂ particles or effectively supporting MoS₂ with Co(or Ni) has been actively carried out. Further, it is known in the thesis (Catalysis Today 45 (1998) 271-276, Catalysis Today 130 (2008) 75-79, Journal of Catalysis 229 (2005) 424-438) that chelating compounds [ethylene diaminetetraacetic acid (EDTA), nitrilotriacetic acid (NTA), trans-1,2-cyclohexanediamine-N,N,N,N′-tetraacetic acid (cyDTA)] or ethylene glycol are generally used in order to accelerate the formation of active sites.

As conventional technologies using a chelating agent, U.S. Pat. No. 5,891,821 discloses a method of improving a hydrodesulfurization efficiency using a water-soluble amine, for example, ethylenediamine or monoethanolamine. Further, European Patent Application Publication EP1 043 069 A1 discloses a method of improving catalytic activity by providing an additive (a molecule including one or more nitrogen atoms and one or more carbonyl groups) to a catalyst including an alumina carrier supported with 26 wt % MoO₃, 4.7 wt % NiO and 6.7 wt % P₂O₅. It was described in an Example of EP1 043 069 A1 that the hydrodesulfurization efficiency of a dry catalyst was improved when the catalyst was supported with EDTA.

Therefore, improved catalysts, particularly, effective catalysts having high activity, are still required to be developed in spite of various descriptions in Patents and Published Documents for hydroprocessing catalysts. Recently, such hydroprocessing catalysts have been widely applied to deoxygenation and denitrogenation reactions and the like as well as a conventional desulfurization reaction. Particularly, considering that these hydroprocessing catalysts are used to hydrogenate animal and plant oils as well as to treat hydrocarbon oils derived from petroleum or coal, it can be seen that the necessity of hydroprocessing catalysts having high activity is more increased.

### SUMMARY

Embodiments of the invention provide a method for preparing a hydroprocessing catalyst. According to various embodiments, the method includes supporting a carrier with one or more hydrogenation metal components selected from the group consisting of VIB, VIIB, and VIII group metals of the periodic table; drying and calcining the supported carrier having the one or more hydrogenation metal components; supporting the supported carrier having the one or more hydrogenation metal components with an organic compound, and drying and calcining the supported carrier having the one or more hydrogenation metal components and the organic compound.

According to at least one embodiment, the one or more hydrogenation metal components and the organic compound are supported in the carrier. According to at least one embodiment, the organic compound is selected from the group consisting of methyl acetoacetate, ethyl acetoacetate and a mixture thereof.

According to at least one embodiment, the one or more hydrogenation metal components supported in the carrier is sulfide. According to at least one embodiment, an amount of the organic compound is 15 wt % to 90 wt % based on the total amount of the hydroprocessing catalyst.

According to at least one embodiment, the one or more hydrogenation metal components is at least one metal selected from the group consisting of molybdenum (Mo), tungsten (W), cobalt (Co), and nickel (Ni).

According to at least one embodiment, the carrier is alumina, silica, silica-alumina, titanium oxide, a molecular sieve, zirconia, aluminum phosphate, carbon, niobia, or a mixture thereof.

According to at least one embodiment, the method further includes supporting, prior to the step of supporting the carrier with the one or more hydrogenation metal components, the carrier with phosphorus, fluorine, chlorine, bromine, boron, or a mixture thereof.

### BRIEF DESCRIPTION OF THE DRAWINGS

These and other features, aspects, and advantages of the invention are better understood with regard to the following Detailed Description, appended Claims, and accompanying FIGURE. It is to be noted, however, that the FIGURE illustrates only various embodiments of the invention and are therefore not to be considered limiting of the invention's scope as it may include other effective embodiments as well.

FIG. 1 is a graph showing characteristics of Cobalt sulfidation according to methyl acetoacetate impregnation according to an embodiment of the invention.

### DETAILED DESCRIPTION

Advantages and features of the invention and methods of accomplishing the same will be apparent by referring to embodiments described below in detail in connection with the accompanying drawings. However, the invention is not limited to the embodiments disclosed below and may be implemented in various different forms. The embodiments are provided only for completing the disclosure of the invention and for fully representing the scope of the invention to those skilled in the art.

According to at least one embodiment, there is provided a hydroprocessing catalyst including (i) one or more hydrogenation metal components selected from the group consisting of VIB, VIIB and VIII group metals; and (ii) an organic compound represented by Chemical Formula 1:

R₁COCH₂COR₂ (1)

(wherein, R₁ and R₂ are identical to or different from each other, and are one or more groups selected from the group consisting of C₁-C₁₂ alkyl, C₆-C₁₂ allyl, C₁-C₁₂ alkoxy and hydroxy), wherein the hydroprocessing catalyst is supported in a carrier or may not be supported in a carrier.

In accordance with another embodiment, the hydroprocessing catalyst includes: (i) one or more hydrogenation metal components selected from the group consisting of VIB, VIIB and VIII group metals, and (ii) an organometallic compound represented by Chemical Formula 2:

X(R₁COCH₁COR₂)n (2)

(wherein, X is selected from the group consisting of VIB, VIIB and VIII group metals, R₁ and R₂ are identical to or different from each other and are one or more groups selected from the group consisting of C₁-C₁₂ alkyl, C₆-C₁₂ allyl, C₁-C₁₂ alkoxy and hydroxy, and n is an integer of 1-6), wherein the hydroprocessing catalyst may be supported in a carrier or may not be supported in a carrier.

In another embodiment of the invention, the hydroprocessing catalyst is prepared by supporting a carrier with (i) one or more hydrogenation metal components selected from the group consisting of VIB, VIIB and VIII group metals, and (ii) the organic compound represented by Chemical Formula 1 above or the organometallic compound represented by Chemical Formula 2 above.

As the catalyst supporting method, methods generally known in the conventional art such as impregnation, precipitation, ion exchange, and the like, may be used without limitation.

According to at least one embodiment, the hydroprocessing catalyst includes a hydrorefining catalyst, a hydrotreating catalyst, a hydrocracking catalyst, and the like, which are respectively used in a hydrorefining process, a hydrotreating process, a hydrocracking process and the like.

According to at least one embodiment, the carrier is alumina, silica, silica-alumina, titanium oxide, a molecular sieve, zirconia, aluminum phosphate, carbon, niobia or a mixture thereof. Examples of the molecular sieve include ZSM-5, ZSM-12, ZSM-21, ZSM-22, ZSM-23, ZSM-35, ZSM-38, ZSM-48, ZSM-57, SSZ-32, ferrite, SAPO-11, SAPO-31, SAPO-41, MAPO-11, MAPO-31, X-zeolite, Y-zeolite, L-zeolite, beta-zeolite, SBA-15, MCM-41, MCM-48 and the like.

According to at least one embodiment, the hydrogenation metal component is at least one metal component selected from the group consisting of VIB, VIIB and VIII group metals. For example, the hydrogenation metal component is at least one metal component selected from the group consisting of molybdenum (Mo), tungsten (W), cobalt (Co) and nickel (Ni).

According to at least one embodiment, the amount of the hydrogenation metal component is suitably adjusted depending on whether or not a catalyst is supported, the kind of a carrier and whether or not a catalyst is sulfurized. For example, the amount of the hydrogenation metal component is 1-95 wt %, and preferably 2-90 wt %, based on the total amount of the hydroprocessing catalyst. When the amount of the hydrogenation metal component is less than 1 wt %, the processing catalyst cannot sufficiently exhibit hydroprocessing activity.

According to at least one embodiment, the organic compound represented by Chemical Formula 1 above is acetyl acetone, methyl acetoacetate, ethyl acetoacetate, dimethyl malonate, malonic acid or a mixture thereof. Preferably, the organic compound is acetyl acetone, methyl acetoacetate, ethyl acetoacetate or a mixture thereof. More preferably, the organic compound is methyl acetoacetate, ethyl acetoacetate or a mixture thereof.

According to at least one embodiment, the organometallic compound represented by Chemical Formula 2 above is a compound in which methyl acetoacetate, ethyl acetoacetate, methyl molonate or malic acid is bonded with a metal component such as cobalt, nickel, molybdenum or tungsten. Preferably, the organometallic compound is a compound in which methyl acetoacetate or ethyl acetoacetate is bonded with a metal component such as cobalt, nickel, molybdenum or tungsten. More preferably, the organometallic compound is a compound in which methyl acetoacetate or ethyl acetoacetate is bonded with a metal component such as cobalt or nickel. This organometallic compound is prepared by reacting a metal salt with the organic compound and a basic component.

Further, the organometallic compound represented by Chemical Formula 2 above is a mixture of methyl acetoacetate, ethyl acetoacetate, methyl molonate or malic acid and cobalt, nickel, molybdenum or tungsten. Preferably, the organometallic compound is a mixture of methyl acetoacetate or ethyl acetoacetate and cobalt, nickel, molybdenum or tungsten. More preferably, the organometallic compound is a mixture of methyl acetoacetate or ethyl acetoacetate and cobalt or nickel.

According to at least one embodiment, the amount of the organic compound or the organometallic compound is 15-90 wt % based on the total amount of the hydroprocessing catalyst. Preferably, the amount of the organic compound or the organometallic compound is 30-80 wt % based on the total amount of the hydroprocessing catalyst. When the amount of the organic compound or the organometallic compound is less than 15 wt %, the amount of formation of the high-activity active sites, for example, Co(or Ni)Mo(or W)S is so small in the hydroprocessing catalyst that the hydroprocessing activity of the hydroprocessing catalyst is bad or similar to the conventional catalysts which use chelating compounds [ethylene diaminetetraacetic acid (EDTA) or citric acid. When the amount of the organic compound or the organometallic compound is more than 90 wt %, the increase in activity of the hydroprocessing catalyst to the added organic compound or organometallic compound is slight, which is not economically preferable.

According to at least one embodiment, the hydroprocessing catalyst further includes phosphorus (P), fluorine (F), chlorine (Cl), bromine (Br), boron (B) or a mixture thereof in order to increase the reaction activity thereof by changing the structure of metal (active site) or the properties of a carrier. The amount thereof is 30 wt % or less, and preferably 1-10 wt %, based on the total amount of the processing catalyst. These additives reduce the interaction of metals with the support or enhance the dispersion of Mo and Co species, which increase the number of active sites or create new sites with a high intrinsic active site. When the amount of the additive component is more than 10 wt %, the catalytic activity is decreased because of the reducing of support surface area.

According to at least one embodiment, the hydroprocessing catalyst is used in a process of selectively removing one or more of sulfur, oxygen and nitrogen by a hydrotreatment reaction.

According to at least one embodiment, a method of supporting a carrier with (i) one or more hydrogenation metal components selected from the group consisting of VIB, VIIB and VIII group metals, and (ii) the organic compound represented by Chemical Formula 1 above or the organometallic compound represented by Chemical Formula 2 above is performed by a general supporting method. This method is performed separately or simultaneously.

According to another embodiment, when the carrier supporting method is separately performed, a method of preparing a hydroprocessing catalyst further includes the steps of (a) supporting a carrier with at least one hydrogenation metal component selected from the group consisting of VIB, VIIB and VIII group metals, and then drying, calcining, or drying and then calcining the carrier, and (b) supporting the carrier obtained in step (a) with the organic compound represented by Chemical Formula 1 above or the organometallic compound represented by Chemical Formula 2 above and then drying, calcining or drying and then calcining the carrier.

In step (a) or (b), the drying of the carrier is performed at 70° C.-350° C., and preferably at 100° C.-350° C. Further, the calcining of the carrier is performed at 351° C.-70° C., and preferably at 351° C.-600° C.

According to at least one embodiment, in step (b) a base is further added in addition to the organic compound. For example, the base is selected from among ammonia, amines, anilines, pyridines, hydroxides, carbonates and mixtures thereof.

According to at least one embodiment, the hydroprocessing catalyst further includes phosphorus, fluorine, chlorine, bromine, boron or a mixture thereof. In another embodiment, a carrier is supported with phosphorus, fluorine, chlorine, bromine, boron or a mixture thereof. Specifically, the method of preparing a hydroprocessing catalyst further includes the step of supporting a carrier with phosphorus, fluorine, chlorine, bromine, boron or a mixture thereof and then drying, calcining or drying and then calcining the carrier, before step (a) or (b).

According to another embodiment, when the carrier supporting method is simultaneously performed, a method of preparing a hydroprocessing catalyst further includes the steps of (A) supporting a carrier with at least one hydrogenation metal component selected from the group consisting of VIB, VIIB and VIII group metals, and the organic compound represented by Chemical Formula 1 above or the organometallic compound represented by Chemical Formula 2 above; and (B) drying, calcining or drying and then calcining the carrier obtained in step (A).

According to at least one embodiment, in step (A), the hydroprocessing catalyst furthers include phosphorus, fluorine, chlorine, bromine, boron or a mixture thereof. In another embodiment of the invention, a carrier is supported with phosphorus, fluorine, chlorine, bromine, boron or a mixture thereof. Specifically, the method of preparing a hydroprocessing catalyst further includes the step of supporting a carrier with phosphorus, fluorine, chlorine, bromine, boron or a mixture thereof and then drying, calcining or drying and then calcining the carrier, before step (A) or (B).

According to at least one embodiment, a method of preparing a catalyst supported with the organometallic compound represented by Chemical Formula 2 above includes a method of preparing a catalyst directly using the organometallic compound represented by Chemical Formula 2 above.

As described above, since a catalyst supported with the organic compound represented by Chemical Formula 1 above or the organometallic compound represented by Chemical Formula 2 above is prepared by various methods, the method according to various embodiments of the invention is not limited to the above-mentioned methods.

According to at least one embodiment, the hydroprocessing catalyst is converted into metal sulfide and then used, and the hydroprocessing catalyst, prepared by a general treatment method, is sulfurized. For example, the metal supported in the catalyst is converted into metal sulfide by treating the catalyst at a high temperature of 120-450° C. in the presence of hydrogen using only an organic sulfur compound or H₂S or using a mixed solution of a sulfur compound and a solvent. The sulfidation of the catalyst is performed by a general method commonly known in the conventional art, and is not limited to the above-mentioned method.

Embodiments of the invention provide non-obvious advantages over conventional hydroprocessing catalysts. For example, the hydroprocessing catalyst of the present invention, which includes an organic compound represented by Chemical Formula 1 above or an organometallic compound represented by Chemical Formula 2 above, has higher activity than that of a conventional hydroprocessing catalyst, since the organic compound or the organometallic compound gives high hydroprocessing activities to the hydroprocessing catalyst by increasing the formation of activity sites.

Further, the hydroprocessing catalyst according to various embodiments of the invention is effective at hydrogenating (deoxygenating) animal and plant oils containing fatty acid or triglyceride as a main ingredient as well as hydrogenating hydrocarbon oil derived from petroleum or coal.

Moreover, the hydroprocessing catalyst according to various embodiments of the invention exhibits high activity in the hydrogenation reaction of hydrocarbon fractions derived from various processes, and exhibits remarkable effects in the desulfurization, denitrogenation and/or deoxygenation reactions of hydrocarbon containing one or more of sulfur, nitrogen and oxygen.

Hereinafter, embodiments of the invention will be described in more detail with reference to the following Examples. However, the scope of the invention is not limited to these Examples.

### Example 1: Preparation of a CoMo/Al₂O₃ Catalyst

A CoMo/Al₂O₃ catalyst was prepared as follows.

First, ammonium heptamolybdate tetrahydrate (AHM) was dissolved in distilled water to obtain an aqueous solution. An Al₂O₃ carrier having a diameter of 1 mm was impregnated with the aqueous solution, dried at 150° C. for 2 hours, and then continuously calcined at 500° C. for 2 hours to prepare a MoO₃/Al₂O₃ catalyst.

Cobalt nitrate hexahydrate (CNH) was dissolved in distilled water to obtain an aqueous solution. Then, the MoO₃/Al₂O₃ catalyst was impregnated with the aqueous solution, and then dried at 150° C. for 2 hours to prepare a catalyst including about 15 wt % of molybdenum and about 4 wt % of cobalt using an Al₂O₃ carrier having a diameter of 1 mm. Thereafter, methyl acetoacetate (MeAA) was mixed with distilled water in an amount of 15 wt % based on the weight of a dry catalyst to obtain a mixed solution, the mixed solution was added to the catalyst, and then this catalyst was dried at 150° C. for 2 hours to prepare a CoMo/Al₂O₃ catalyst. In the preparation of the CoMo/Al₂O₃ catalyst, ammonium heptamolybdate tetrahydrate (AHM) was used as a molybdenum (Mo) precursor, but various types of molybdenum (Mo) precursors may be used instead of AHM. Further, cobalt nitrate hexahydrate (CNH) was used as a cobalt (Co) precursor, but various types of cobalt (Co) precursors may be used instead of CNH.

### Example 2: Preparation of a CoMo/Al₂O₃ Catalyst

A CoMo/Al₂O₃ catalyst was prepared in the same manner as in Example 1, except that MEAA was mixed with distilled water in an amount of 90 wt % based on the weight of a dry catalyst.

### Example 3: Preparation of a CoMo/Al₂O₃ Catalyst

A CoMo/Al₂O₃ catalyst was prepared in the same manner as in Example 1, except that MEAA was mixed with distilled water in an amount of 95 wt % based on the weight of a dry catalyst.

### Example 4: Preparation of a CoMo/Al₂O₃ Catalyst

A CoMo/Al₂O₃ catalyst was prepared by calcining the catalyst prepared in Example 1 at 500° C. for 2 hours.

### Example 5: Preparation of a CoMo/Al₂O₃ Catalyst

AHM and CNH were dissolved in distilled water to obtain an aqueous solution. Then, an Al₂O₃ carrier was impregnated with the aqueous solution, and then dried at 150° C. for 2 hours to prepare a catalyst. Thereafter, methyl acetoacetate (MeAA) was mixed with distilled water in an amount of 15 wt % based on the weight of a dry catalyst to obtain an aqueous MeAA solution, the aqueous MeAA solution was added to the catalyst, and then this catalyst was dried at 150° C. for 2 hours to prepare a CoMo/Al₂O₃ catalyst.

### Example 6: Preparation of a CoMo/Al₂O₃ Catalyst

A CoMo/Al₂O₃ catalyst was prepared in the same manner as in Example 1, except that a mixed solution in which acetylacetone is mixed with ethanol in an amount of 13 wt % based on the weight of a dry catalyst was added instead of the aqueous MeAA solution.

### Example 7: Preparation of a CoMo/Al₂O₃ Catalyst

A CoMo/Al₂O₃ catalyst was prepared in the same manner as in Example 1, except that a mixed solution in which ethyl acetoacetate is mixed with ethanol in an amount of 18 wt % based on the weight of a dry catalyst was added instead of the aqueous MeAA solution.

### Example 8: Preparation of a CoMo/Al₂O₃ Catalyst

A CoMo/Al₂O₃ catalyst was prepared in the same manner as in Example 1, except that a mixed solution in which dimethyl malonate is mixed with ethanol in an amount of 18 wt % based on the weight of a dry catalyst was added instead of the aqueous MeAA solution.

### Example 9: Preparation of a CoMo/Al₂O₃ Catalyst

A CoMo/Al₂O₃ catalyst was prepared in the same manner as in Example 1, except that a mixture of ammonia water and the aqueous MeAA solution was added.

### Example 10: Preparation of a CoMo/Al₂O₃ Catalyst

AHM, CNH and MeAA were dissolved in distilled water in the same amounts as in Example 1 to obtain an aqueous solution. Subsequently, an Al₂O₃ carrier was impregnated with the aqueous solution, and then dried at 150° C. for 2 hours to prepare a CoMo/Al₂O₃ catalyst.

### Example 11: Preparation of a CoMo/Al₂O₃ Catalyst

A mixed solution in which cobalt methyl acetoacetate (II) is mixed with methanol in an amount of 18 wt % (based on cobalt) based on the weight of a dry catalyst was added to the MoO₃/Al₂O₃ prepared in Example 1, and then dried at 150° C. for 2 hours to prepare a CoMo/Al₂O₃ catalyst.

### Comparative Example 1: Preparation of a CoMo/Al₂O₃ Catalyst

A CoMo/Al₂O₃ catalyst including about 15 wt % of molybdenum and about 4 wt % of cobalt was prepared using an alumina carrier having a diameter of 1 mm as follows. First, AHM was dissolved in distilled water to obtain an aqueous solution. An Al₂O₃ carrier was impregnated with the aqueous solution, dried at 150° C. for 2 hours, and then continuously calcined at 500° C. for 2 hours to prepare a MoO₃/Al₂O₃ catalyst.

CNH was dissolved in distilled water to obtain an aqueous solution. Then, the MoO₃/Al₂O₃ catalyst was impregnated with the aqueous solution, dried at 150° C. for 2 hours, and then continuously calcined at 500° C. for 2 hours to prepare a MoO₃/Al₂O₃ catalyst.

### Comparative Example 2: Preparation of a CoMo/Al₂O₃ Catalyst

A CoMo/Al₂O₃ catalyst was prepared in the same manner as in Example 1, except that a mixed solution in which EDTA is mixed with ammonia water and distilled water in an amount of 30 wt % based on the weight of a dry catalyst was added instead of the aqueous MeAA solution.

### Comparative Example 3: Preparation of a CoMo/Al₂O₃ Catalyst

ACoMo/Al₂O₃ catalyst was prepared in the same manner as in Example 1, except that MEAA was mixed with distilled water in an amount of 12 wt % based on the weight of a dry catalyst to obtain a mixed solution.

### Comparative Example 4: Preparation of a CoMo/Al₂O₃ Catalyst

ACoMo/Al₂O₃ catalyst was prepared in the same manner as in Example 1, except that MEAA was mixed with distilled water in an amount of 5 wt % based on the weight of a dry catalyst to obtain a mixed solution.

### Comparative Example 5: Preparation of a CoMo/Al₂O₃ Catalyst

A CoMo/Al₂O₃ catalyst was prepared in the same manner as in Example 1, except that a mixed solution in which citric acid is mixed with distilled water in an amount of 23 wt % based on the weight of a dry catalyst was added instead of the aqueous MeAA solution.

### Test Example 1

Each of the catalysts prepared in the above methods was sulfided by the following sulfidation method, and then hydroprocessing reaction is carried out. The results thereof are shown in Table 1 below. As shown in Table 1, when the hydrogenation metal components supported in the carrier is sulfided, the organic compound or organometallic compound increases the formation of activities sites.

—Sulfidation of Catalyst—

5 g of each of the prepared catalysts (Examples 1 to 11 and Comparative Examples 1 to 5), 77 g of pentadecane and 30 g of dimethyl disulfide were introduced into an autoclave, pressurized by 40 bars of H₂ at room temperature, and then heated to 350° C. to sulfurize the catalyst for 3 hours.

—Hydroprocessing Reaction—

0.1 g of the sulfurized catalyst (particle size: 80-140 mesh), 46 g of pentadecane and 0.06 g of dibenzothiophene (DBT) were introduced into a 100 cc autoclave, and then reacted at 320° C. for 1 hour. Subsequently, the DBT remaining after the reaction was analyzed by GC. Then, a hydroprocessing reaction was carried out, and the hydroprocessing activities of the catalysts were compared.

$$Hydroprocessing activity ( \% ) = \frac{\begin{matrix}DBT content in soln before reaction - \\ DBT content in soln after reaction\end{matrix}}{DBT content in soln before reaction} \times 100$$

TABLE 1

| Catalyst | Hydroprocessing activity |
|---|---|
| Example 1 | 61 |
| Example 2 | 63 |
| Example 3 | 63 |
| Example 4 | 50 |
| Example 5 | 59 |
| Example 6 | 57 |
| Example 7 | 58 |
| Example 8 | 55 |
| Example 9 | 58 |
| Example 10 | 57 |
| Example 11 | 60 |
| Comparative Example 1 | 37 |
| Comparative Example 2 | 45 |
| Comparative Example 3 | 45 |
| Comparative Example 4 | 40 |
| Comparative Example 5 | 45 |

From the results shown in Table 1 above, it can be ascertained that the hydroprocessing activities of the catalysts of Examples 1 to 9, to which an organic compound containing a carbonyl group or a derivative thereof was added, were high, the hydroprocessing activity of the catalyst of Comparative Example 1, which did not include the organic compound, was low, and the hydroprocessing activity of the catalyst of Comparative Example 2, to which EDTA was added instead of the organic compound, was also low. Consequently, it can be ascertained that catalysts having higher activity can be obtained by the addition of the organic compound containing a carbonyl group or a derivative thereof.

It can be also ascertained that the hydroprocessing activities of the catalysts of Comparative Examples 3 and 4, to which an organic compound was added in an amount lower than 15 wt %, was higher than the hydroprocessing activities of the catalysts of Comparative Example 1, which did not include the organic compound, but lower than or similar to the hydroprocessing activities of the catalysts of Comparative Example 2, which included EDTA, or Comparative Example 5, which included citric acid. The hydroprocessing activity of the catalyst of Example 2, in which the amount of MEAA was 90 wt %, was higher than that of Example 1, but the hydroprocessing activity of the catalyst of Example 3, in which the amount of MEAA was 95 wt %, is similar to that of Example 2. Thus, it is not economically preferable to add organic compound or organometallic compound more than 90 wt %.

### Example 12: Preparation of a CoMo/ZrO₂ Catalyst

A CoMo/ZrO₂ catalyst was prepared in the same manner as in Example 1, except that a ZrO₂ carrier was used instead of an Al₂O₃ carrier.

### Comparative Example 6: Preparation of a CoMo/ZrO₂ Catalyst

A CoMo/ZrO₂ catalyst was prepared in the same manner as in Comparative Example 1, except that a ZrO₂ carrier was used instead of an Al₂O₃ carrier.

### Test Example 2

Each of the catalysts of Example 12 and Comparative Example 6 was sulfurized sulfide by the method of Test Example 1, and then the hydroprocessing reaction of oxygen-containing hydrocarbon was carried out. The results thereof are shown in Table 2 below.

—Hydroprocessing Reaction—

0.1 g of the sulfurized catalyst (particle size: 80-140 mesh), 46 g of pentadecane and 0.06 g of dibenzofuran (DBF) were introduced into a 100 cc autoclave, and then reacted at 320° C. for 1 hour. Subsequently, the DBF remaining after the reaction was analyzed by GC. Then, a hydroprocessing reaction was carried out, and the hydroprocessing activities of the catalysts were compared.

$$Hydroprocessing activity ( \% ) = \frac{\begin{matrix}DBF content in soln before reaction - \\ DBF content in soln after reaction\end{matrix}}{DBF content in soln before reaction} \times 100$$

TABLE 2

| Catalyst | Hydroprocessing activity |
|---|---|
| Example 12 | 45 |
| Comparative Example 6 | 31 |

From the results shown in Table 2 above, it can be ascertained that the catalyst, to which an organic compound containing a carbonyl group or a derivative thereof was added, exhibited high hydroprocessing activity in the deoxygenation reaction as well as in the desulfurization reaction of Table 1.

### Example 13: Preparation of a NiMo/Al₂O₃ Catalyst

A NiMo/Al₂O₃ catalyst was prepared in the same manner as in Example 1, except that nickel nitrate hexahydrate (NNH) was used instead of CNH. Here, NNH was used as a nickel (Ni) precursor, but various types of nickel (Ni) precursors may be used instead of NNH.

### Example 14: Preparation of a NiMoP/Al₂O₃ Catalyst

An alumina carrier was supported with an aqueous H₃PO₄ solution, calcined at 500° C. for 2 hours, and then treated in the same manner in Example 13 to prepare a NiMoP/Al₂O₃ catalyst including about 15 wt % of molybdenum (Mo), about 4 wt % of nickel (Ni) and about 3 wt % of phosphorus (P). Here, H₃PO₄ was used as a phosphorus (P) precursor, but various types of phosphorus (P) precursors may be used instead of H₃PO₄.

### Example 15: Preparation of a NiW/Al₂O₃ Catalyst

A NiW/Al₂O₃ catalyst was prepared in the same manner as in Example 13, except that ammonium metatungstate hydrate (AMT) was used instead of AHM. Here, AMT was used as a tungsten (W) precursor, but various types of tungsten (W) precursors may be used instead of AMT.

### Comparative Example 7: Preparation of a NiMo/Al₂O₃ Catalyst

A NiMo/Al₂O₃ catalyst was prepared in the same manner as in Comparative Example 1, except that NNH was used instead of CNH.

### Comparative Example 8: Preparation of a NiW/Al₂O₃ Catalyst

A NiW/Al₂O₃ catalyst was prepared in the same manner as in Comparative Example 1, except that NNH was used instead of CNH, and AMT was used instead of AHM.

### Test Example 3

Each of the catalysts prepared in the above methods was sulfurized by the following sulfidation method, and was then hydrotreated. The results thereof are shown in Table 3 below.

—Sulfidation of Catalyst—

5 g of each of the prepared catalysts (Examples 13 to 15 and Comparative Examples 7 and 8) was charged in a 6 cc cylindrical reactor, heated to 320° C. while introducing R-LGO containing 3 wt % of dimethyl sulfide (DMDS) into the reactor at flow rate of 0.1 cc/min under the conditions of room temperature, a reaction pressure of 45 bar and a H₂ flow rate of 16 cc/min, and then pretreated at 320° C. for 3 hours.

—Hydroprocessing Reaction—

A hydroprocessing reaction was carried out while introducing light cycle oil (boiling point range: 170-360° C., sulfur content: 0.3 wt %, nitrogen content: 0.03 wt %) at a flow rate of 0.12 cc/min under the conditions of a temperature of 300° C., a pressure of 60 bar and a H₂ flow rate of 60 cc/min, and the results thereof are shown in Table 3 below. Hydroprocessing activity is expressed by a sulfur compound removal rate and a nitrogen compound removal rate.

$$Sulfur removal rate ( \% ) = \frac{S content in soln before rxn - S content in soln after rxn}{S content in soln before rxn} \times 100$$

$$Nitrogen removal rate ( \% ) = \frac{N content in soln before rxn - N content in soln after rxn}{N content in soln before rxn} \times 100$$

TABLE 3

| | Sulfur removal | Nitrogen removal |
|---|---|---|
| | rate (%) | rate (%) |
| Example 13 | 93 | 96 |
| Example 14 | 95 | 97 |
| Example 15 | 92 | 96 |
| Comparative Example 7 | 86 | 91 |
| Comparative Example 8 | 85 | 92 |

From the results shown in Table 3 above, it can be ascertained that the hydroprocessing activities (each of which is expressed by a sulfur compound removal rate and a nitrogen compound removal rate) of the catalysts of Examples 13 to 15, to each of which an organic compound containing a carbonyl group or a derivative thereof was added, were high, and the hydroprocessing activities of the catalysts of Comparative Examples 7 and 8, each of which did not include the organic compound, was low. Consequently, it can be ascertained that catalysts having higher activity can be obtained by the addition of the organic compound.

### Example 16: Preparation of a NiMo/TiO₂ Catalyst

A NiMo/TiO₂ catalyst was prepared in the same manner as in Example 13, except that a TiO₂ carrier was used instead of an Al₂O₃ carrier.

### Comparative Example 9: Preparation of a NiMo/TiO₂ Catalyst

A NiMo/TiO₂ catalyst was prepared in the same manner as in Comparative Example 7, except that a TiO₂ carrier was used instead of an Al₂O₃ carrier.

### Test Example 4

Each of the catalysts of Example 16 and Comparative Example 9 was sulfurized by the method of Test Example 3, and then a hydroprocessing reaction was carried out. The results thereof are shown in Table 4 below.

—Hydroprocessing Reaction—

5 g of the catalyst sulfurized by the method of Test Example 3 was hydrotreated under the conditions of a reaction temperature of 320° C., a reaction pressure of 30 bar and a hydrogen flow rate of 100 cc/min. Soybean oil was used as a feed. Soybean oil was reacted at a reaction rate of 0.1 cc/min (LHSV=1), and the results thereof are shown in Table 4 below. Soybean is converted into a diesel fraction having a boiling point of 221-343° C. by a hydrodeoxygenation or decarboxylation reaction on a catalyst. Hydroprocessing activity is represented by the conversion ratio of soybean oil into diesel included in a reaction product.

$$Hydroprocessing activity ( \% ) = \frac{Weight of product having B . P . of 221 \text{-} 343 ° C . ( wt \% )}{Total weight of products ( wt \% )} \times 100$$

TABLE 4

| Catalyst | Hydroprocessing activity (%) |
|---|---|
| Example 16 | 95 |
| Comparative Example 9 | 89 |

From the results shown in Table 4 above, it can be ascertained that the catalyst exhibited high hydroprocessing activity in the hydroprocessing (deoxygenation) of animal and plant oils containing fatty acid or triglyceride as a main ingredient as well as in the hydroprocessing of sulfur, nitrogen and oxygen components included in hydrocarbons derived from petroleum or coal.

### Test Example 5

Object: Test for characteristics of Cobalt sulfidation according to methyl acetoacetate impregnation.

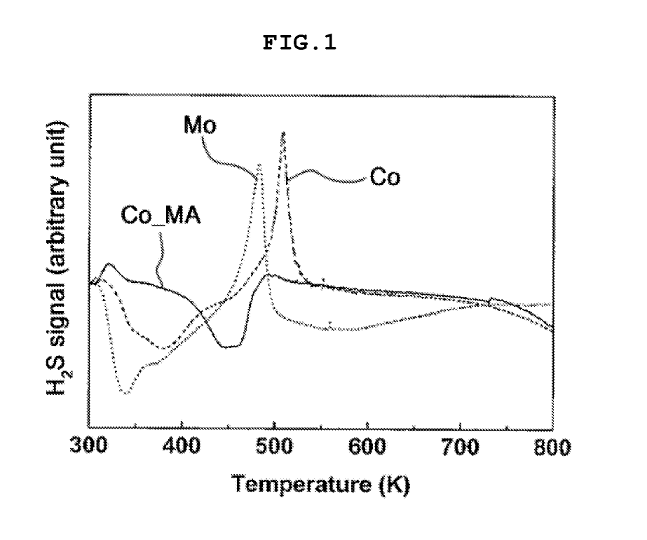

Result: The impregnation of methyl acetoacetate contributed to formation of CoMoS phase, which is an active phase, by delaying a sulfidaton of Cobalt. The result is shown in FIG. 1.

Reason: When Co is sulfurized before Mo, formation of inactive Cobaltsulfide increases.

Experiment: H₂ gas containing 10% H₂S is injected. Characteristics of metal sulfidaton is measured with increasing temperature (amount of H₂S is measured). FIG. 1 shows a qualitative analysis. Thus, the units of H₂S signal are an arbitrary units in FIG. 1.

Preparing a Sample:

Co: Co(NO₃)₂ is impregnated into alumina, which is a support of a catalyst. Drying is performed at 150° C. for 2 hr to obtain Co impregnated sample.

Co_MA: Methyl Acetoacetate is impregnated into the Co impregnated sample. Drying is performed at 150° C. for 2 hr to obtain Co_MA impregnated sample.

Mo: Ammonium hepta molybdate is impregnated alumina support. Calcining is performed at 500° C. for 2 hr to obtain Mo impregnated sample.

Explanation: In the case of Mo, the negative peak appeared at 315-450 K due to the consumption of H₂S during the transformation of MoO₃ into a molybdenum oxi-sulfide (MoO₃₋ₓSₓ) or MoS₃-like phases by exchanging oxygens with sulfur atoms. A sharp positive peak of H₂S evolution was obserbed at 450-500 K because of the reduction of MoO₃₋ₓSₓ or MoS₃ into MoO₃₋ₓS_{x-y} or MoS₂.

In the case of Co, a broad negative peak was observed at 330-440 K due to the consumption of H₂S during Co sulfidation, which is almost similar to that of Mo at 315-450 K. A sharp peak was observed at 490-530 K in the case of Co. Evolution of this sharp peak was ascribed to the production of H₂S following the hydrogenation of elemental sulfur produced by the reaction of NO₃ with H₂S.

In Co_MA, the broad peak of H₂S consumption was observed at 400-500 K, indicating that Co_MA was sulfided at higher temperatures compared with Co.

It is consider that this promoted a formation of CoMoS (active phase). In conclusion, the selection of the particular organic compounds (methyl acetoacetate, ethyl acetoacetate and a mixture thereof) confers higher hydroprocessing activity on the catalyst.

Although the embodiments of the invention have been disclosed for illustrative purposes, it will be appreciated that the present invention is not limited thereto, and those skilled in the art will appreciate that various modifications, additions and substitutions are possible, without departing from the scope and spirit of the invention. Accordingly, any and all modifications, variations or equivalent arrangements should be considered to be within the scope of the invention, and the detailed scope of the invention will be disclosed by the accompanying claims.

1. A method for preparing a hydroprocessing catalyst, the method comprising:
supporting a carrier with one or more hydrogenation metal components selected from the group consisting of VIB, VIIB, and VIII group metals of the periodic table;
drying and calcining the supported carrier having the one or more hydrogenation metal components;
supporting the supported carrier having the one or more hydrogenation metal components with an organic compound, and
drying and calcining the supported carrier having the one or more hydrogenation metal components and the organic compound,
wherein the one or more hydrogenation metal components and the organic compound are supported in the carrier,
wherein the organic compound is selected from the group consisting of methyl acetoacetate, ethyl acetoacetate and a mixture thereof,
wherein the one or more hydrogenation metal components supported in the carrier is sulfided,
wherein an amount of the organic compound is 15 wt % to 90 wt % based on the total amount of the hydroprocessing catalyst.

2. The method of claim 1, wherein the one or more hydrogenation metal components is at least one metal selected from the group consisting of molybdenum (Mo), tungsten (W), cobalt (Co), and nickel (Ni).

3. The method of claim 1, wherein the carrier is alumina, silica, silica-alumina, titanium oxide, a molecular sieve, zirconia, aluminum phosphate, carbon, niobia, or a mixture thereof.

4. The method of claim 1, further comprising:
supporting, prior to the step of supporting the carrier with the one or more hydrogenation metal components, the carrier with phosphorus, fluorine, chlorine, bromine, boron, or a mixture thereof.
